(19) United States
(12) Patent Application Publication
(10) Pub. No.: US 2022/0128980 A1
(43) Pub. Date: Apr. 28, 2022

(54) AUTOMATION CODE GENERATOR FOR INTEROPERABILITY ACROSS INDUSTRIAL ECOSYSTEMS

(71) Applicant: Siemens Aktiengesellschaft, Munich (DE)

(72) Inventors: Hartmut Ludwig, West Windsor, NJ (US); Florian Ersch, Plainsboro, NJ (US); Lingyun Wang, Princeton, NJ (US)

(21) Appl. No.: 17/427,156

(22) PCT Filed: Feb. 17, 2020
(86) PCT No.: PCT/US2020/018489

§ 371 Date: Jul. 30, 2021

Related U.S. Application Data
(60) Provisional application No. 62/807,053, filed on Feb. 18, 2019.

(51) Int. Cl. G05B 19/418; G06F 8/30; G06F 9/54

(52) U.S. Cl. CPC G05B 19/41845; G05B 2219/32137; G06F 9/541; G06F 8/30

(57) ABSTRACT

Current approaches to integrating industrial ecosystems, for instance integrating automation functions across different vendors, lack efficiencies and capabilities. For example, system integrators are often required to develop special software that functions as a proxy or adaptor between different systems. In such cases, the proxy or adaptor is often specific to a particular set of equipment or vendors, and which can limit reusability, among other technical drawbacks. Embodiments described herein overcome e one or more of the described-herein shortcomings or technical problems by providing methods, systems, and apparatuses for automatically generating interfaces, for instance glue code, that enables interoperability between different ecosystems in automated industrial systems.

### CROSS-REFERENCE TO RELATED APPLICATIONS

This application claims the benefit of U.S. Provisional Application Ser. No. 62/807,053 filed on Feb. 18, 2019, the disclosure of which is incorporated herein by reference in its entirety.

### BACKGROUND

Automation systems can be used to control the operation of machines and other components in a systematic manner. Automation systems can include various automation domains such as factory automation, process automation, building automation, energy automation, and the like. Automation systems can also include equipment from multiple vendors. In some cases, equipment and machines within an automation system may use varying mechanisms associated with their respective ecosystems, such as varying runtime environments, protocols, and programming languages (e.g., vendor-specific programming languages). By way of example, automation functions are often platform specific and/or are implemented in a proprietary manner. Thus, generating an automation function that is interoperable with other automation functions can be cumbersome and time-consuming.

Current approaches to integrating industrial ecosystems, for instance integrating automation functions across different vendors, lack efficiencies and capabilities. For example, system integrators are often required to develop special software that functions as a proxy or adaptor between different systems. In such cases, the proxy or adaptor is often specific to a particular set of equipment or vendors, which can limit reusability, among other technical drawbacks.

### BRIEF SUMMARY

Embodiments of the invention address and overcome one or more of the described-herein shortcomings or technical problems by providing methods, systems, and apparatuses for automatically generating interfaces, for instance glue code, that enables interoperability between different ecosystems in automated industrial systems. In an example aspect, a generator module can receive a request from a first ecosystem that defines a first programming language native to the automation equipment of the first ecosystem. The generator module can determine that the first programming language is native to the automation equipment of the first ecosystem. Based on the request, the generator module can determine that a second ecosystem is involved in fulfilling the request. In some examples, the second ecosystem defines a second programming language that is native to the automation equipment of the second ecosystem. The generator module can determine that the second programming language is native to the automation equipment of the second ecosystem. Based on the request and responsive to determining that the first and second ecosystems define first and second programming languages, respectively, the generator module can generate an output. The output can include an interface between the first and second ecosystems. An interface can define code that translates the request such that the request from the first ecosystem can be satisfied at least in part by the second ecosystem. For example, the interface can include a first portion that is compatible with the first programming language. The interface can also include a second portion that is compatible with the second programming language. Continuing with the example, the generator module can send the first portion and the second portion to the automation equipment of the first ecosystem and the second ecosystem, respectively. Further, based on the first and second portions, the request can be fulfilled. Fulfilling the request may include performing, by one or more of the physical assets of the second ecosystem, an industrial task that is involved in manufacturing a product. In some examples, after the first portion of code is sent to the first ecosystem, the first ecosystem is able to interoperate with other ecosystems in addition to the second ecosystem without generating other code for the first ecosystem. Similarly, after the second portion of the code is generated, in some cases, the second ecosystem can work with different ecosystems without generating additional code for the second ecosystem.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram of an example automation system that includes an abstraction layer and a generator module in accordance with an example embodiment.

FIG. 2 is a block diagram that illustrates another example automation system and an example use case for the automation system, in accordance with an example embodiment.

FIG. 3 illustrates a product controller and gantry station of the example automation system shown in FIG. 2, and an interface that is generated by the generator module in accordance with an example embodiment.

FIG. 4 is a block diagram of an example generator system that includes the generator module in accordance with an example embodiment.

FIG. 5 illustrates an example input to the generator module in accordance with an example embodiment.

FIG. 6 illustrates an example output automatically generated by the generator module in response to the input depicted in FIG. 5, in accordance with an example embodiment.

FIG. 7 illustrates a continuation of the example output illustrated in FIG. 6.

FIG. 8 illustrates another example output automatically generated by the generator module in response to the input depicted in FIG. 5, in accordance with an example embodiment.

FIG. 9 illustrates an example data block (DB) that can be generated by the generator module in response to the input depicted in FIG. 5, in accordance with an example embodiment.

FIG. 10 is a block diagram that depicts various outputs that can be generated due to the interactions of the components depicted in the example system of FIG. 3.

FIG. 11 is a flow diagram that depicts an example operation of the generator system according to an example embodiment.

FIG. 12 illustrates an example of a computing environment within which embodiments of the disclosure may be implemented.

### DETAILED DESCRIPTION

In some cases, a system integrator may rely on various industrial standards (e.g., OPC Unified Architecture (UA), data distribution service (DDS)) to bridge different ecosystems together. It is recognized herein, however, that additional efforts are often required to integrate functionality with data and models in a given standard, such as standards within the OPC UA. For example, special client and server adaptors, or additionally layers, may need to be developed to support integration and interoperability. It is further recognized herein that overhead associated with integration and interoperability may degrade non-functional requirements, such as performance and scalability for example. Furthermore, technical solutions developed by system integrators might only be suitable for a specific task, which may limit reusability of the solution.

In various embodiments described herein, automation code is automatically generated so as to bridge different ecosystems, programming languages, platforms, and the like, together. Thus, in accordance with various embodiments, automation functions that are engineered in one ecosystem can freely interact with automation functions that are engineered in other ecosystems that can be different from one another. By way of example, a programmable logic controller (PLC) manufactured by a first vendor in a first ecosystem can freely operate with a robot manufactured by a second vendor in a second ecosystem, without a system integrator having to perform one or more system integration tasks. For example, data can be exchanged between the first and second ecosystems without a system integrator having to transform the data into a common data standard, such as OPC for example. Thus, in accordance with various embodiments described herein, ecosystem owners can focus on their own business logic in their preferred platforms without having to use resources for integration. By way of example, a supplier can design robots that perform pick and place functions, a factor owner can develop an automation system that performs an assembly, and mechanisms that enable the robots and the automation system to interoperate with each other can be automatically generated in accordance with embodiments described herein.

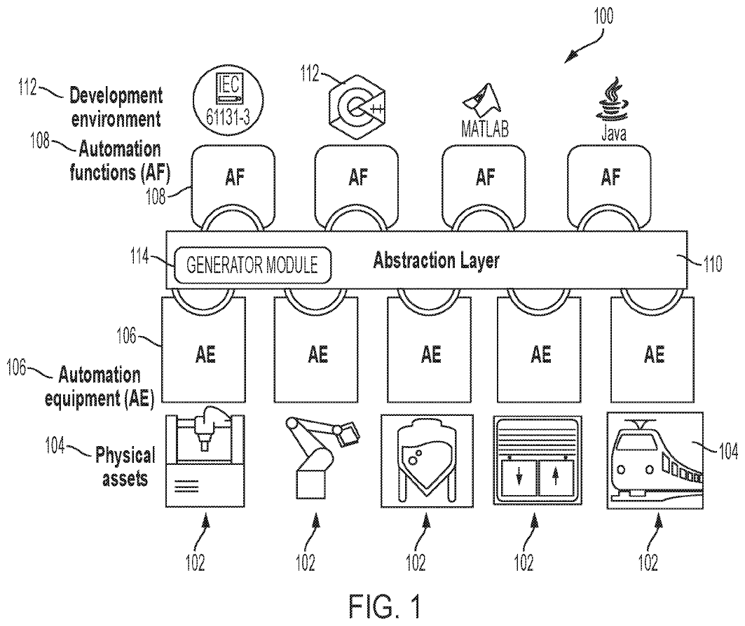

Referring now to FIG. 1, an example automation system 100 defines a plurality of ecosystems or domains 102. Each ecosystem 102 can include physical assets 104 that can be controlled by automation equipment 106 configured to control the respective automation equipment 106. The automation equipment 106 may be specific to one or more physical assets 104 in the respective ecosystem 102. The automation system can further include automation functions 108 and an abstraction layer 110 that abstracts (exposes) the automation functions 108 that can be performed by the automation equipment 106 and the physical assets 104. It will be understood that the illustrated environment automation system 100 is simplified for purposes of explanation. The automation system 100 may vary as desired, and all such systems are contemplated as being within the scope of this disclosure.

Still referring to FIG. 1, the abstraction layer 110 can abstract various functional characteristics, which are illustrated as automation functions 108, from the automation equipment 106. The automation functions 108 can be soft-wired together, such that the abstraction layer 110 can serve as an intermediary between various development environments 112 and various automation equipment 106. Thus, the automation system 100, in particular the abstraction layer 110, can provide functionality corresponding to a physical component, for instance the automation equipment 106 and/or physical assets 104. In doing so, developers can operate in one or more development environments 112, for instance a development environment of their choice, to use various automation functions 108, via the abstraction layer 110, and the automation functions 108 can be performed by the automation equipment 106 and physical assets 104. In particular, the abstraction layer 100 can enable automation functions 108 from different domains 102 to interoperate with one another. The development environments 112 may define one or more languages or platforms, such as Java, C, Matlab, Python, Siemens Totally Integrated Automation (TIA) Portal, or the like. Thus, various development environments 112 can utilize various automation equipment 106 from various domains 102, via the abstraction layer 102.

In accordance with various embodiments, the abstraction layer 110 can include a generator module or automation code generator 114, which is further described herein. The abstraction layer 110 can execute in a runtime environment, so as to provide interfaces to the automation functions 108. The abstraction layer 110, and thus the generator module 114, can be implemented on a server, a cloud-based computing environment, a vendor-specific runtime platform environment, or other industrial computing system, such as a computer system 510.

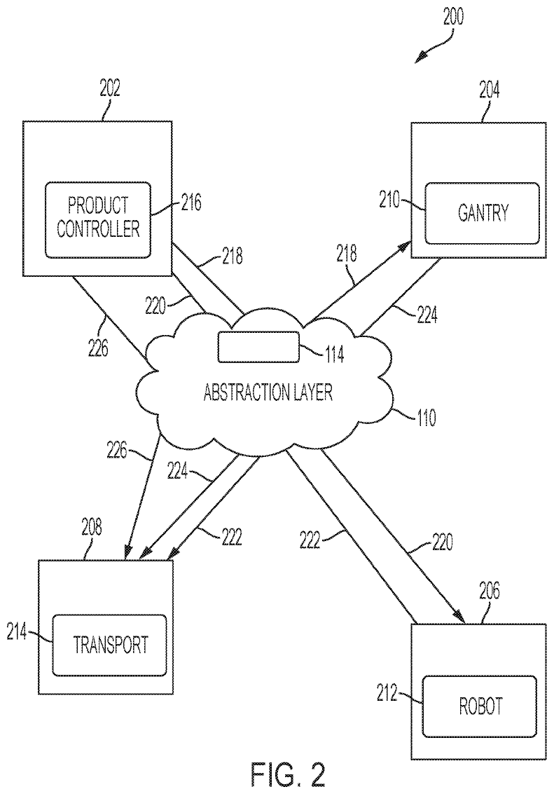

Turning now to the generator module 114, an example use case for the generator 114 is illustrated in FIG. 2. Referring to FIG. 2, an example industrial automation system 200 can include the plurality of ecosystems 102, for instance a first or product ecosystem 202, a second or production ecosystem 204, a third or production ecosystem 206, and a fourth or production ecosystem 208. The example industrial system 200 can define or be part of a factory, such as a factory for manufacturing or assembling various products. In accordance with the example, the second ecosystem 204 includes a gantry station 210, the third ecosystem 206 includes a robot station 212, and the fourth ecosystem 208 includes a transport station 214, though it will be understood that the production ecosystems can include any stations as desired. It will further be understood that while four ecosystems of the example automation system 200 are illustrated, automation systems described herein may include any number of ecosystems, and all such systems are contemplated as being within the scope of this disclosure.

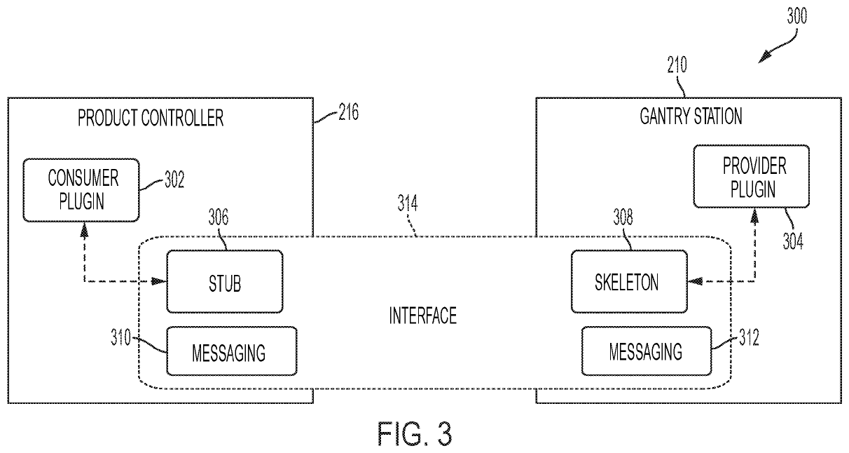

Each production ecosystem 204, 206, and 208 of the industrial automation system 200 can offer or provide various production skills so as to perform various industrial tasks, such as for example pick and place, transport, assembly, or the like. The product ecosystem 202 can use or consume one or more of the production ecosystems 204, 206, and 208 to assemble or manufacture one or more products. Example products include a lego car, cube tray, controller cabinet assembly, rivet assembly, car door assembly, or the like, though it will be understood that any product that requires machine operations can be produced in accordance with embodiments described herein, and all such products are contemplated as being within the scope of this disclosure. Thus, referring also to FIG. 3, the product ecosystem 202 can define, or be referred to as, a consumer ecosystem 302, and the production ecosystems 202, 204, and 206 can define respective provider ecosystems, such as a first provider ecosystem 304.

With continuing reference to FIG. 2, in some cases, the gantry station 210, robot station 212, and transport station 214 can each be provided from different equipment vendors, which can create interoperability issues addressed herein, among other challenges. By way of example, the product ecosystem 202 can include automation equipment, for instance a product controller 216, that is associated with a product that is assembled or manufactured by the industrial automation system 200. By way of example, the product controller 216 can be PC-based, and can be programmed by a first programming language, such as C for example. The product controller 216 can perform various activities during the lifecycle of a given product. For example, during a design state, a desired state of a given product can be established within the product controller 216. The desired state may refer to the overall condition of a product or machine during or after production. The desired state may indicate various information such as, for example, absolute position information, position information relative to other physical assets, temperature limitation, stress level limitations, or the like. The desired state may be determined from inputs to the product controller 216 such as, for example and without limitation, a Bill of Process (BOP), Bill of Materials (BOM), properties of the materials, and 3D models (e.g., CAD models) or other physical models of the product.

In some cases, aspects of the product may be manually defined based on user input. In some examples, processing is partially or entirely automated. In an example embodiment, the product controller 216 includes text processing utilities for extracting relevant information from standard BOP and BOM documents. The product controller 216 can also include processing utilities for understanding physical models of the product or the manufacturing environment. In an example, after the relevant information is extracted from the inputs, the information can be used to set values for the desired state of the product managed by the product controller 216. In some embodiments, these values may be set based on a set of rules coded into the product controller 216. In other examples, the product controller 216 may include one or more machine learning models trained to generate inputs based on information similar to the extracted information.

During a production state, by way of further example, the product controller 216 can control production of its product by communicating with sensors that are configured to monitor the product. Based on information that is received from sensors, the product controller 216 can compare an actual product state to the desired state. Based on the comparison, in some cases, the product controller 216 can identify machines or functions, for instance via the abstraction layer 110, within the industrial automation system 200 to realize the desired state. For example, the product controller can invoke, via the abstraction layer 110 various automation equipment of the gantry station 210, robot station 212, or transport station 214 to achieve a particular desired state.

As a practical example, during an assembly of an automobile, in particular the installation of a door onto the automobile's body, the product ecosystem 202 can include a PC or product controller 216 that corresponds to the automobile, and thus may know or determine information related to a desired state of the automobile at various steps of the assembly process. Such information may include, for example and without limitation, the position of the car door with respect to the automobile body. As further described herein, the PC or product controller 216 of the product ecosystem 202 can communicate with the production ecosystems, via the abstraction layer 110, to complete assembly of the automobile.

The gantry station 210 can be controlled by automation equipment from Siemens, such as one or more programmable logic controllers (e.g., SIMATIC S7-1517) that is programmed in a second programming language (e.g., IEC61131 in a TIA Portal engineering environment). Continuing with the example, the robot station 212 can be controlled by automation equipment from Kuka, such as a Kuka controller that is programmed in a third programming language (e.g., Java-based). The transport station 214 can be controlled by automation equipment from MagneMotion that provides control nodes programmed in a fourth programming language (e.g., Web or C++ based). Thus, without being bound by the specific examples, the functionality of each station 210, 212, and 214 and product controller 216 can be programmed with languages and tools supported by the equipment vendor of its respective ecosystem.

With continuing reference to FIG. 2, an example product assembly or production is now described. At 218, the product controller 216 sends a requests that the gantry station 210 performs a pick and place operation on parts of a given product. The request can be received by the abstraction layer 110.

In particular, referring also to FIG. 3, an example pick and place operation 300 is shown that includes interactions between the product ecosystem 202 and the gantry station 210. Pick and place can refer to any operation that involves a robot picking up objects and placing them somewhere else. In accordance with an example embodiment, stub 306 and a skeleton 308, which can be collectively referred to as glue code or as an interface, can be automatically generated by the generator module 114. The stub 306 and the skeleton 308 can enable the product ecosystem 202 and the production ecosystem 204 to operate with each other. The product controller 216 of the product ecosystem 202 can define a consumer plugin 302. The gantry station 210 of the production ecosystem 204 can define a provider plugin 304. In the example, the production ecosystem 204 provides a service, in particular pick and place, for the product ecosystem 202, and the product ecosystem 202 consumes the service. The consumer plugin 302 can include code associated with how to use pick and place operations to assemble the product of the product ecosystem 202. The code of the consumer plugin 302 can be programmed in the programming language that is native to the product ecosystem, for instance C language on a PC, Rasberry Pi, or Linux. Similarly, the provider plugin 304 can include code associated with how to implement pick and place operations using controllers, drives, and motors of the gantry station 210. For example, the provider plugin 304 can be programmed in an IEC61131 language using SIMATIC TIA portal tools on an S7-1517 programmable logic controller.

Continuing with the above example, the stub 306 can be PC-based and can include functions implemented in a dynamic link library (DLL) or a static library. Such a library can be inserted in the product ecosystem 202, for instance the library can be stored by the product controller 216. Similarly, the skeleton 308 can be based on a language of a controller of the gantry station 210 (e.g., SIMATIC), and can include function blocks and data blocks (DBs) in IEC1131, for example. The skeleton 308 can be stored within the production ecosystem 204 so as to be accessible by automation equipment within the production ecosystem 204. Consequently, in some cases, users can focus on the business logic within their preferred platforms that resides within their own ecosystem because the integration mechanisms or glue code can be automatically generated by the generator module 114. In particular, continuing with the example, a supplier of the gantry station 210 can focus on automation functions of the gantry station 210 (e.g., pick and place function of robots within the gantry station 210), and a product user or factor owner can focus on developing automation applications within the platform of the product ecosystem 202. By way of further example, the product user can program the product logic in a first programming language, such as C/C++ programming language, against the interface 314 from a C library. Similarly, the gantry station 210 provider can implement the pick and place logic in a second programming language, such as the SIMATIC/IEC61131 environment, as the interface 314 generated by the generator module 114 can include a portion (e.g., skeleton 308) in the second programming language. Further, the stub 306 and skeleton 308 use a messaging system 308 and 310, respectively, that enables communication across ecosystems. The messaging systems 308 and 310 can realize the common interface mapping, as the messaging systems 308 and 310 can provide underlying communications between different ecosystems, in particular between a given stub and skeleton. In some cases, users do not interact with the messaging systems 308 and 310, such that the messaging systems 308 and 310 are hidden.

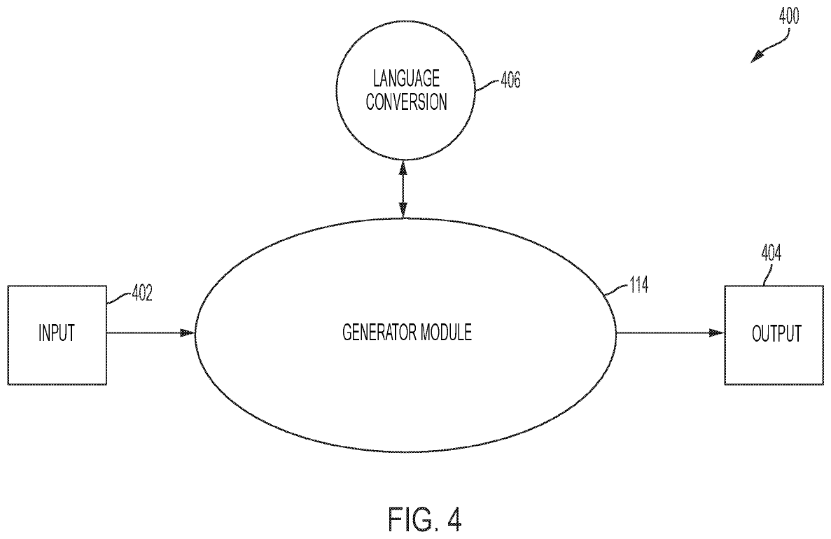

Referring also to FIG. 4, an example generator system 400 includes the generator module 114 that can be part of the abstraction layer 110. Referring also to FIGS. 3 and 4, the generator module 114 can receive a request or input 402 from any ecosystem, for instance the ecosystems depicted in the example systems 300 and 400, for example. In response to the input 402, the generator module 114 can generate an output 404. The generator system 400 can further include a language conversion module 406 configured to translate logic from one programming language to another programming language. By way of example, the language conversion module 406 can perform various routines so as to convert different languages to the C language. By way of another example, the language conversion module 406 can convert from the C language to an internal common mapping language (e.g., serializer/de-serializer).

In an example, the input 402 includes a request. The generator module 114 can receive the request from a first ecosystem that defines a first programming language native to the automation equipment of the first ecosystem. The generator module 114 can determine that the first programming language is native to the automation equipment of the first ecosystem. Based on the request, the generator module 114 can determine that a second ecosystem is involved in fulfilling the request. In some examples, the second ecosystem defines a second programming language that is native to the automation equipment of the second ecosystem. The generator module 114 can determine that the second programming language is native to the automation equipment of the second ecosystem. Based on the request and responsive to determining that the first and second ecosystems define first and second programming languages, respectively, the generator module 114 can generate the output 404. The output 404 can include an interface, for instance the interface 314, between the first and second ecosystems. An interface, for instance the interface 314, can define code that translates the request such that the request from the first ecosystem can be satisfied at least in part by the second ecosystem. For example, the interface can include a first portion (e.g., stub 306) that is compatible with the first programming language. The interface can also include a second portion (e.g., skeleton 308) that is compatible with the second programming language. Continuing with the example, the generator module 114 can send the first portion and the second portion to the automation equipment of the first ecosystem and the second ecosystem, respectively. Based on the first and second portions, the request can be fulfilled. Fulfilling the request can include performing, for instance by one or more of the physical assets of the second ecosystem, an industrial task that is involved in manufacturing a product.

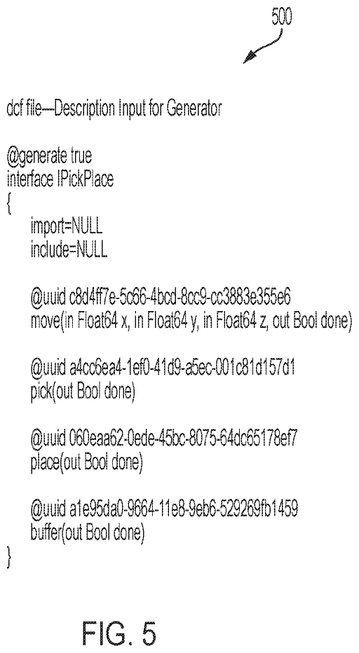

Referring again to FIGS. 2-4, and also to FIG. 5, at 218, the product controller 216 can send a request to the generator module 114 on the abstraction layer 110. The request can indicate or include the input 402. In some examples, the input 402 includes one or more interface description language (IDL) files, for instance an input file 500. In some cases, an interface description language file, and thus the input 402, can describe a functional interface for one or more automation functions. The input file 500 can be input to the generator module 114 as part of the example described with reference to FIG. 3. Thus, for example, the input file 500 can indicate the function interface for the product controller 216. In particular, the input file 500 can indicate an interface for pick and place operations, and parameters associated with the pick and place operations. In some cases, the pick and place operations include discreet functions such as picking, placing, and buffering.

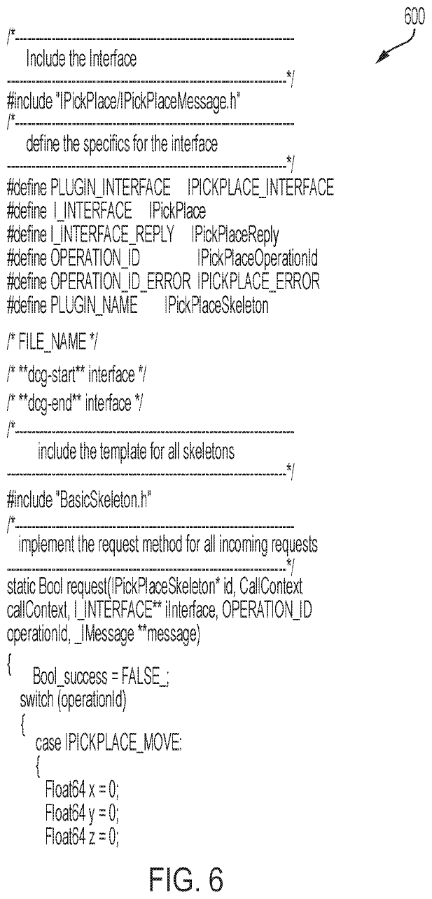

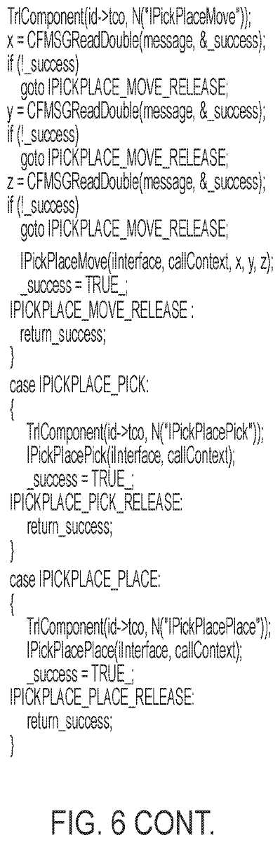

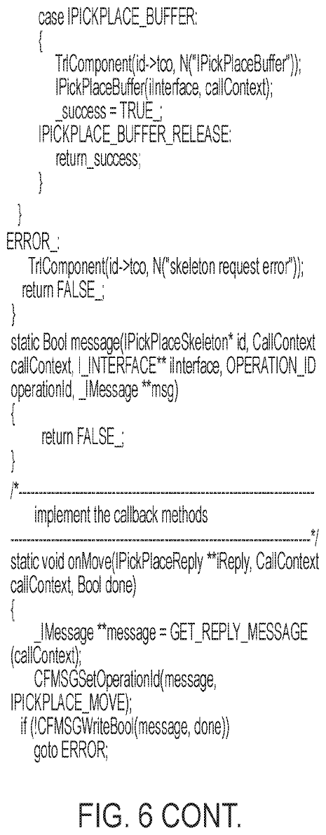

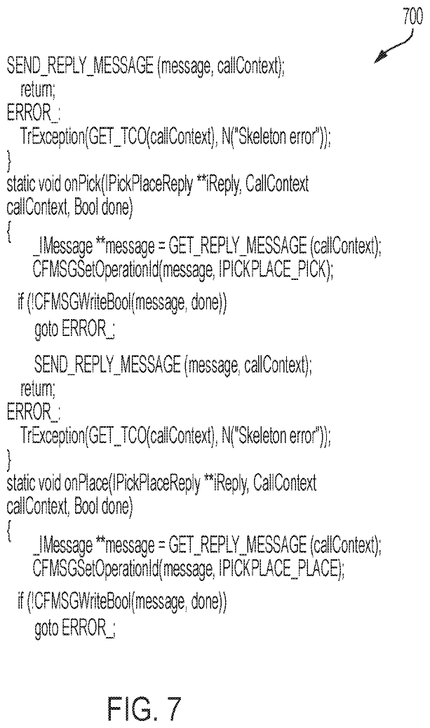

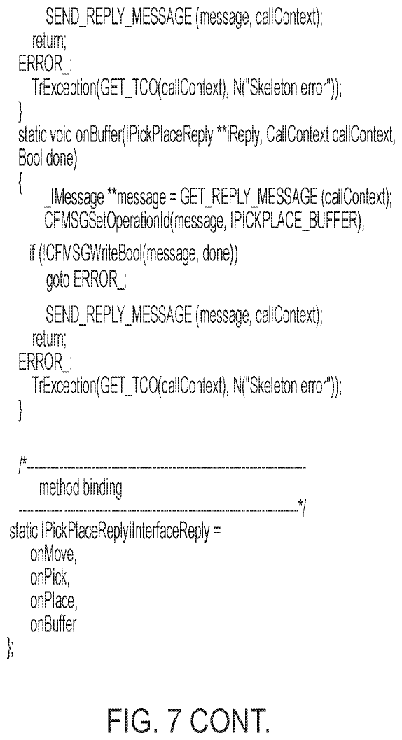

Continuing with the above-described example, and referring also to FIGS. 6 and 7, based on the input file 500, the generator module 114 can generate glue code. The glue code can define the interface 314, for example. The glue code can define one or more stubs and skeletons, for instance the stub 306 and the skeleton 308. The stub 306 can define code for a PC platform of the product ecosystem 202, such as pick and place code 600 and 700. Thus, in response to the input file 500, the generator module 114 can generate the pick and place code 600 and 700. Further, the pick and place code 600 and 700 can be sent to the product ecosystem 202, in particular the product controller 216.

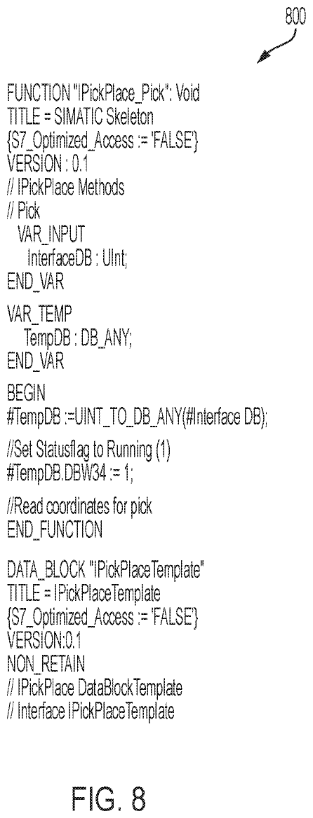

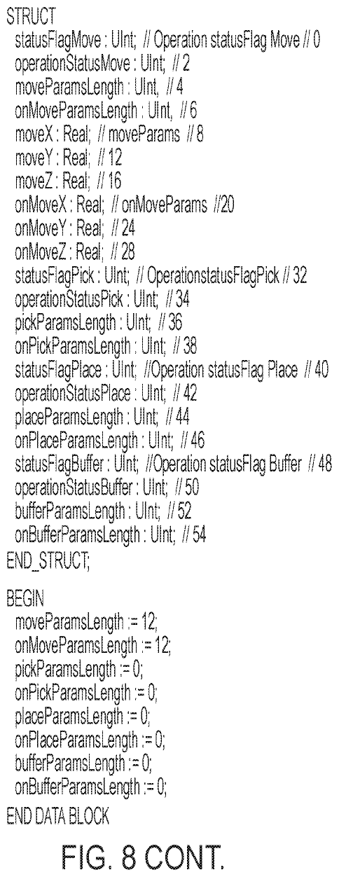

Similarly, referring to FIG. 8, the skeleton 308 can define code for a vendor-specific industrial platform of the production ecosystem 204, such as a pick and place interface 800. Thus, in response to the input file 500, the generator module 114 can generate the pick and place interface 800. In an example, the pick and place interface 800 can be used in a TIA portal for programming a programmable logic controller (PLC) of the gantry station 210. Thus, in an example, the pick and place interface 800 is generated in an SCL language such that it can be used in the TIA portal to program the gantry station 210. The pick and place interface 800 can be sent to the production ecosystem 204, in particular the automation equipment of the gantry station 210. By way of example, the pick and place code 600 and 700 can be template code that is generated in C/C++ by the generator module 114, and the pick and place interface 800 can be template code in SCL for the TIA portal, which is also generated by the generator module 114. In some cases, implementation details (e.g., product logic and gantry operation logic) can be further programmed based on the generated pick and place code 600 and 700 and the pick and place interface 800. Continuing with the example, the stub and skeleton are generated by the generator module 114, and function in between the pick and place code 600 and 700, and the pick and place interface 800.

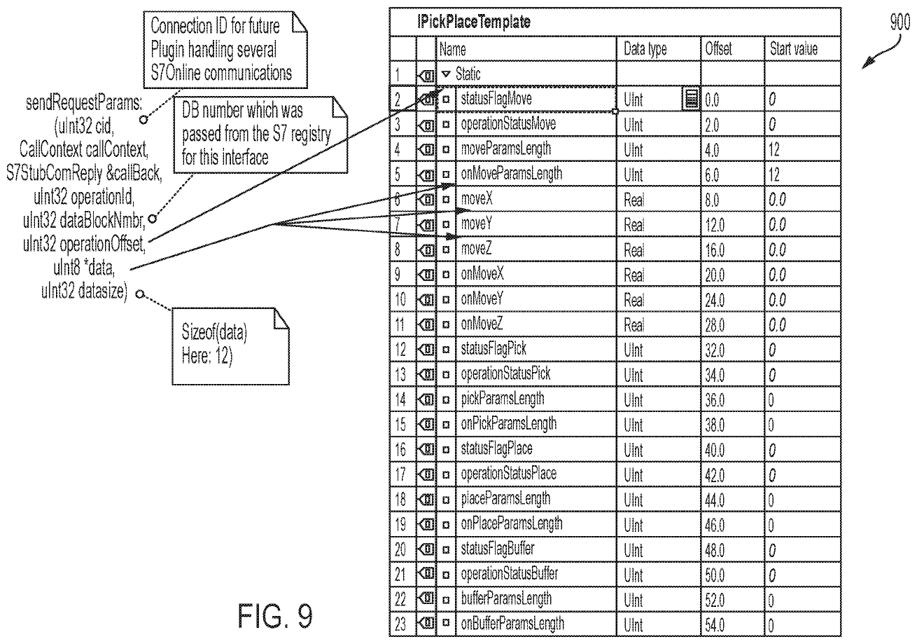

Referring also to FIG. 9, as described above, the output 404 can also include data blocks, for instance a data block 900. In an example, the data block 900 is used for communication on an IEC61131 compatible PLC.

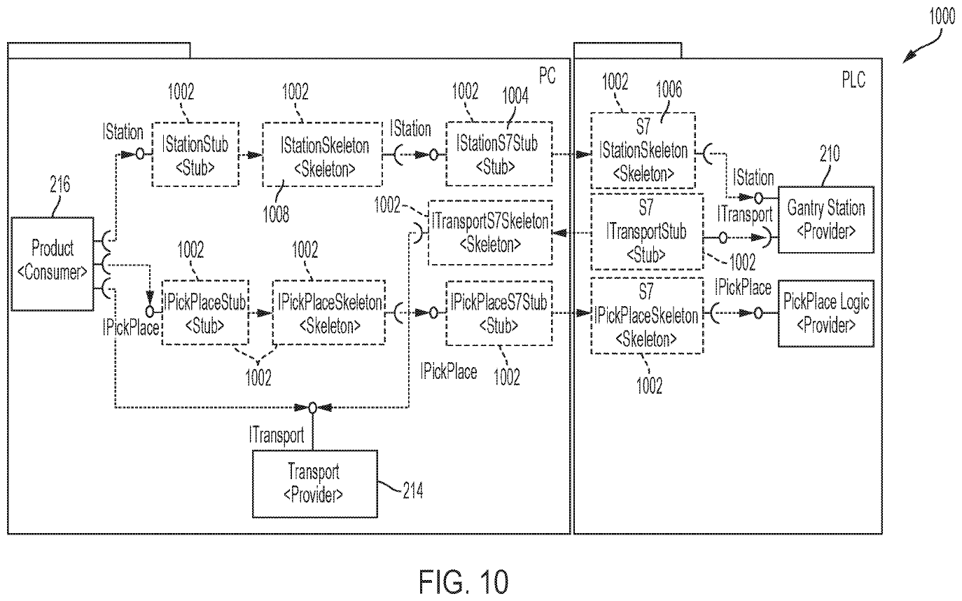

It will be understood that the pick and place examples discussed herein (e.g., with reference to FIGS. 3 and 5-9) are simplified for purposes of explanation. The generator module 114, and thus an automation system, can generate code for different functions across any ecosystems as desired, and all such systems are contemplated as being within the scope of this disclosure. For example, referring again to FIG. 2, and also to FIG. 10, the generator module 114 can generate glue code for at least a portion, for instance all, of a production process. In particular, at 226, the product controller 216 can request that the transport station 214 move a given product to an assembly station, such as the gantry station 210, for assembly. When the product arrives at the gantry station 210, at 218, the product controller 216 can request that the gantry station perform a pick and place operation, as described herein. In response, the generator module 114 can generate code such as generated code 1002. In particular, the generated code 1002 can include controller stub 1004 and controller skeleton 1006, which enables the request to cross a communication protocol (e.g., S7) boundary that can be used by the controller of the gantry station 210. For example, the pair of stub 1004 and skeleton 1006 can be used to route a function call from skeleton 1008 to the gantry station 210. Similarly, at 226, the product controller 216 can request that the transport station 214 move a given product to another assembly station, such as the robot station 212, for assembly. At 220, the product controller 216 can request that the robot station 212 perform a desired operation. At 222, for example when the robot station 212 has completed an assembly operation, the robot station 212 can request that the transport station 214 moves the product, for instance to a storage location. Similarly, at 224, when the gantry station 210 has completed its pick and place operations, for example, the gantry station 210 can request that the transport station 214 moves the product, for instance to a storage location.

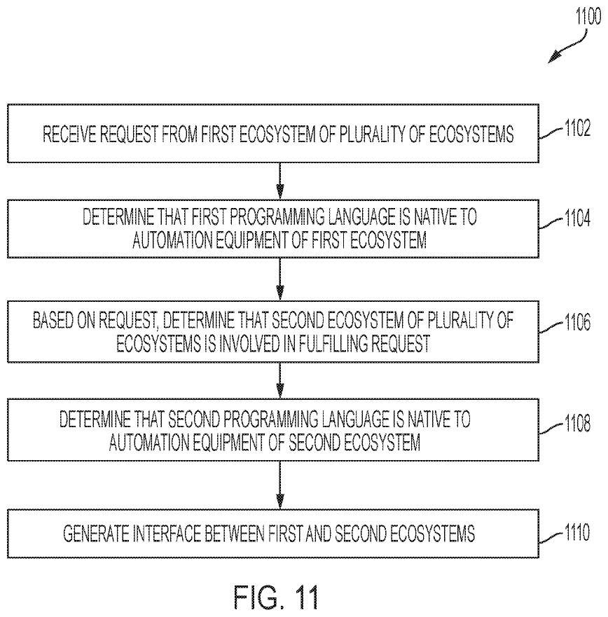

Referring now to FIG. 11, an example routine 1100 can be performed by a generator, for instance the generator system 400, in accordance with various embodiments described herein. At 1102, the generator system receives a request, for instance a first request, from a first ecosystem of the plurality of ecosystems. The first ecosystem defines a first programming language native to the automation equipment of the first ecosystem. At 1104, the generator system determines that the first programming language is native to the automation equipment of the first ecosystem. At 1106, based on the first request, the generator determines that a second ecosystem of the plurality of ecosystems is involved in fulfilling the first request. In accordance with the example, the second ecosystem defines a second programming language native to the automation equipment of the second ecosystem. At 1108, the generator determines that the second programming language is native to the automation equipment of the second ecosystem. At 1110, based on the first request and responsive to determining that the first and second ecosystems define first and second programming languages, respectively, the generator system generates an interface between the first and second ecosystems. The interface defines code that translates the request such that the request from the first ecosystem can be satisfied at least in part by the second ecosystem. The code defined by the interface can include a first portion compatible with the first programming language and a second portion compatible with the second programming language. The generator system can send the first portion and the second portion to the automation equipment of the first ecosystem and the second ecosystem, respectively.

In an example, based on the first and second portions of the interface, the first request is fulfilled. Fulfilling the first request can include performing, by one or more of the physical assets of the second ecosystem, a first industrial task that is involved in manufacturing a first product. After sending the first portion to the automation equipment of the first ecosystem, the generator system can receive another request, for instance a second request, from the first ecosystem. Based on the second request, the generator system can determine that a third ecosystem of the plurality of ecosystems is involved in fulfilling the second request. The third ecosystem can define a third programming language native to the automation equipment of the third ecosystem. Based on the second request, the generator can generate code, for instance a third portion of code, for the third ecosystem without re-generating the first portion of code. The second request can be fulfilled based on the first and third portions of code. Fulfilling the second request can include performing, by one or of the physical assets of the third ecosystem, a second industrial task that is involved in manufacturing a second product.

Similarly, after sending the second portion to the automation equipment of the second ecosystem, the generator system can receive a new request from another ecosystem, for instance a new ecosystem, of the plurality of ecosystems. Based on the new request, the generator system can determine that the second ecosystem is involved in fulfilling the new request. Based on the new request, the generator can generate a new portion of code for the new ecosystem without re-generating the second portion of code. Based on the second portion of code and the new portion of code for the new ecosystem, the new request can be fulfilled. Fulfilling the new request can include performing, by one or more physical assets of the new ecosystem, a new industrial task that is involved in manufacturing a new product.

Additionally, or alternatively, based on the first request, the generator system can determine a third ecosystem of the plurality of ecosystems that is associated with fulfilling the first request. The third ecosystem can define a third programming language native to the automation equipment of the third ecosystem. Based on the first request and responsive to determining that the second and third ecosystems define second and third programing languages, respectively, the generator can generate a second interface between the second and third ecosystems. The second interface can define code that translates the second programming language such that the first request from the first ecosystem can be satisfied at least in part by the third ecosystem.

In accordance with various embodiments described herein, a system integrator is not needed for automation tasks, as the generator module 114 can generate glue code to enable interoperability across a plurality of ecosystems. Further, after the glue code, for instance the stub 306 and skeleton 308, is generated, it can be used for future applications that follow the application for which it was generated. That is, for example, the product controller 216 can interoperate with other gantry stations besides the gantry station 210, without further integration efforts, which run on the same platform as the gantry station 210. Similarly, the gantry station 210 can interoperate with other ecosystems after its interface to the abstraction layer is generated by the generator module 114, without further integration experts. Further, by way of example, if the gantry station 210 replaces one of its robots, the product controller 216 need not take any action to interoperate with the new robot. Rather, the interface from the new robot to the abstraction layer 110 can be generated by the generator module 114, and then the product controller 216 can invoke the new robot, via the abstraction layer 110. It is recognized herein that in scenarios where robots are replaced or updated, production is often stalled or stopped. In embodiments described herein, however, the product logic of the product controller 216 need not change because the product controller can interoperate with a different robot or different ecosystem entirely, for instance the robot station 212, to complete its operations.

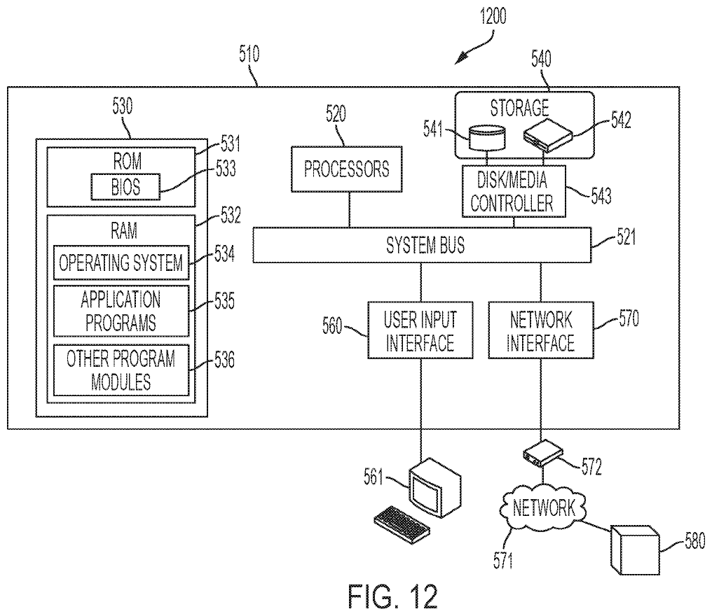

FIG. 12 illustrates an example of a computing environment within which embodiments of the present disclosure may be implemented. A computing environment 1200 includes a computer system 510 that may include a communication mechanism such as a system bus 521 or other communication mechanism for communicating information within the computer system 510. The computer system 510 further includes one or more processors 520 coupled with the system bus 521 for processing the information. The robot device 104 may include, or be coupled to, the one or more processors 520.

The processors 520 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 520 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 521 may include at least one of a system bus, a memory bus, an address bus, or a message bus, and may permit exchange of information (e.g., data (including computer-executable code), signaling, etc.) between various components of the computer system 510. The system bus 521 may include, without limitation, a memory bus or a memory controller, a peripheral bus, an accelerated graphics port, and so forth. The system bus 521 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 12, the computer system 510 may also include a system memory 530 coupled to the system bus 521 for storing information and instructions to be executed by processors 520. The system memory 530 may include computer readable storage media in the form of volatile and/or nonvolatile memory, such as read only memory (ROM) 531 and/or random access memory (RAM) 532. The RAM 532 may include other dynamic storage device(s) (e.g., dynamic RAM, static RAM, and synchronous DRAM). The ROM 531 may include other static storage device(s) (e.g., programmable ROM, erasable PROM, and electrically erasable PROM). In addition, the system memory 530 may be used for storing temporary variables or other intermediate information during the execution of instructions by the processors 520. A basic input/output system 533 (BIOS) containing the basic routines that help to transfer information between elements within computer system 510, such as during start-up, may be stored in the ROM 531. RAM 532 may contain data and/or program modules that are immediately accessible to and/or presently being operated on by the processors 520. System memory 530 may additionally include, for example, operating system 534, application programs 535, and other program modules 536. Application programs 535 may also include a user portal for development of the application program, allowing input parameters to be entered and modified as necessary.

The operating system 534 may be loaded into the memory 530 and may provide an interface between other application software executing on the computer system 510 and hardware resources of the computer system 510. More specifically, the operating system 534 may include a set of computer-executable instructions for managing hardware resources of the computer system 510 and for providing common services to other application programs (e.g., managing memory allocation among various application programs). In certain example embodiments, the operating system 534 may control execution of one or more of the program modules depicted as being stored in the data storage 540. The operating system 534 may include any operating system now known or which may be developed in the future including, but not limited to, any server operating system, any mainframe operating system, or any other proprietary or non-proprietary operating system.

The computer system 510 may also include a disk/media controller 543 coupled to the system bus 521 to control one or more storage devices for storing information and instructions, such as a magnetic hard disk 541 and/or a removable media drive 542 (e.g., floppy disk drive, compact disc drive, tape drive, flash drive, and/or solid state drive). Storage devices 540 may be added to the computer system 510 using an appropriate device interface (e.g., a small computer system interface (SCSI), integrated device electronics (IDE), Universal Serial Bus (USB), or FireWire). Storage devices 541, 542 may be external to the computer system 510.

The computer system 510 may also include a field device interface 565 coupled to the system bus 521 to control a field device 566, such as a device used in a production line. The computer system 510 may include a user input interface or GUI 561, which may comprise one or more input devices, such as a keyboard, touchscreen, tablet and/or a pointing device, for interacting with a computer user and providing information to the processors 520.

The computer system 510 may perform a portion or all of the processing steps of embodiments of the invention in response to the processors 520 executing one or more sequences of one or more instructions contained in a memory, such as the system memory 530. Such instructions may be read into the system memory 530 from another computer readable medium of storage 540, such as the magnetic hard disk 541 or the removable media drive 542. The magnetic hard disk 541 and/or removable media drive 542 may contain one or more data stores and data files used by embodiments of the present disclosure. The data store 540 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 520 may also be employed in a multi-processing arrangement to execute the one or more sequences of instructions contained in system memory 530. In alternative embodiments, hard-wired circuitry may be used in place of or in combination with software instructions. Thus, embodiments are not limited to any specific combination of hardware circuitry and software.

As stated above, the computer system 510 may include at least one computer readable medium or memory for holding instructions programmed according to embodiments of the invention and for containing data structures, tables, records, or other data described herein. The term “computer readable medium” as used herein refers to any medium that participates in providing instructions to the processors 520 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 541 or removable media drive 542. Non-limiting examples of volatile media include dynamic memory, such as system memory 530. Non-limiting examples of transmission media include coaxial cables, copper wire, and fiber optics, including the wires that make up the system bus 521. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 1200 may further include the computer system 510 operating in a networked environment using logical connections to one or more remote computers, such as remote computing device 580. The network interface 570 may enable communication, for example, with other remote devices 580 or systems and/or the storage devices 541, 542 via the network 571. Remote computing device 580 may be a personal computer (laptop or desktop), a mobile device, a server, a router, a network PC, a peer device or other common network node, and typically includes many or all of the elements described above relative to computer system 510. When used in a networking environment, computer system 510 may include modem 672 for establishing communications over a network 571, such as the Internet. Modem 672 may be connected to system bus 521 via user network interface 570, or via another appropriate mechanism.

Network 571 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 510 and other computers (e.g., remote computing device 580). The network 571 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 571.

It should be appreciated that the program modules, applications, computer-executable instructions, code, or the like depicted in FIG. 12 as being stored in the system memory 530 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 510, the remote device 580, and/or hosted on other computing device(s) accessible via one or more of the network(s) 571, may be provided to support functionality provided by the program modules, applications, or computer-executable code depicted in FIG. 12 and/or additional or alternate functionality. Further, functionality may be modularized differently such that processing described as being supported collectively by the collection of program modules depicted in FIG. 12 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 12 may be implemented, at least partially, in hardware and/or firmware across any number of devices.

It should further be appreciated that the computer system 510 may include alternate and/or additional hardware, software, or firmware components beyond those described or depicted without departing from the scope of the disclosure. More particularly, it should be appreciated that software, firmware, or hardware components depicted as forming part of the computer system 510 are merely illustrative and that some components may not be present or additional components may be provided in various embodiments. While various illustrative program modules have been depicted and described as software modules stored in system memory 530, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method performed in an industrial system that comprises a plurality of ecosystems that define respective physical assets and automation equipment configured to control the physical assets, the method comprising:
receiving a first request from a first ecosystem of the plurality of ecosystems, the first ecosystem defining a first programming language native to the automation equipment of the first ecosystem;
determining that the first programming language is native to the automation equipment of the first ecosystem;
based on the first request, determining that a second ecosystem of the plurality of ecosystems is involved in fulfilling the first request, the second ecosystem defining a second programming language native to the automation equipment of the second ecosystem;
determining that the second programming language is native to the automation equipment of the second ecosystem; and
based on the first request and responsive to determining that the first and second ecosystems define first and second programming languages, respectively, generating, by a generator module, an interface between the first and second ecosystems,
wherein the interface defines code that translates the first request such that the first request from the first ecosystem can be satisfied at least in part by the second ecosystem.

2. The method of claim 1, wherein the code defined by the interface comprises a first portion compatible with the first programming language and a second portion compatible with the second programming language.

3. The method of claim 2, the method further comprising:
sending the first portion and the second portion to the automation equipment of the first ecosystem and the second ecosystem, respectively; and
based on the first and second portions, fulfilling the first request,
wherein fulfilling the first request comprises performing, by one or more of the physical assets of the second ecosystem, a first industrial task that is involved in manufacturing a first product.

4. The method of claim 3, the method further comprising:
after sending the first portion to the automation equipment of the first ecosystem, receiving a second request from the first ecosystem;
based on the second request, determining that a third ecosystem of the plurality of ecosystems is involved in fulfilling the second request, the third ecosystem defining a third programming language native to the automation equipment of the third ecosystem;
based on the second request, generating, by the generator module, a third portion of code for the third ecosystem without re-generating the first portion of code;
based on the first and third portions of code, fulfilling the second request,
wherein fulfilling the second request comprises performing, by one or of the physical assets of the third ecosystem, a second industrial task that is involved in manufacturing a second product.

5. The method further of claim 3, the method further comprising:
after sending the second portion to the automation equipment of the second ecosystem, receiving a new request from a third ecosystem of the plurality of ecosystems;
based on the new request, determining that the second ecosystem is involved in fulfilling the new request;
based on the new request, generating, by the generator module, a third portion of code for the third ecosystem without re-generating the second portion of code;
based on the second and third portions of code, fulfilling the new request,
wherein fulfilling the new request comprises performing, by one or more physical assets of the third ecosystem, a new industrial task that is involved in manufacturing a new product.

6. The method of claim 1, the method further comprising:
generating, by the generator module, the interface between the first and second ecosystems while the first and second ecosystems are both in a run-time mode.

7. The method of claim 1, the method further comprising:
based on the first request, determining a third ecosystem of the plurality of ecosystems that is associated with fulfilling the first request, the third ecosystem defining a third programming language native to the automation equipment of the third ecosystem.

8. The method of claim 7, the method further comprising:
determining that the third programming language is native to the automation equipment of the third ecosystem; and
based on the first request and responsive to determining that the second and third ecosystems define second and third programing languages, respectively, generating, by the generator module, a second interface between the second and third ecosystems,
wherein the second interface defines code that translates the second programming language such that the first request from the first ecosystem can be satisfied at least in part by the third ecosystem.

9. The method of claim 1, wherein the physical assets of the second ecosystem comprises a robot, the method further comprising:
removing the robot from the second ecosystem; and
replacing the robot in the second ecosystem with a new robot while the second ecosystem is fulfilling the first request.

10. An industrial computing system, the computing system comprising:
a processor; and
a memory storing instructions that, when executed by the processor, configure the apparatus to:
receive a request from a first ecosystem of a plurality of ecosystems, the first ecosystem defining a first programming language native to automation equipment of the first ecosystem;
determine that the first programming language is native to the automation equipment of the first ecosystem;
based on the request, determine that a second ecosystem of the plurality of ecosystems is involved in fulfilling the request, the second ecosystem defining a second programming language native to automation equipment of the second ecosystem;
determine that the second programming language is native to the automation equipment of the second ecosystem; and
based on the request and responsive to determining that the first and second ecosystems define first and second programming languages, respectively, generate an interface between the first and second ecosystems,
wherein the interface defines code that translates the request such that the request from the first ecosystem can be satisfied at least in part by the second ecosystem.

11. The industrial computing system of claim 10, wherein the code defined by the interface comprises a first portion compatible with the first programming language and a second portion compatible with the second programming language.

12. The industrial computing system of claim 10, wherein the instructions further configure the apparatus to:
generate the interface between the first and second ecosystems while the first and second ecosystems are both in a run-time mode.

13. The industrial computing system of claim 10, wherein the instructions further configure the apparatus to:
send the first portion and the second portion to the automation equipment of the first ecosystem and the second ecosystem, respectively; and
execute the first portion and the second portion so as to fulfill the request.

14. The industrial computing system of claim 10, wherein the instructions further configure the apparatus to:
based on the request, determining a third ecosystem of the plurality of ecosystems that is associated with fulfilling the request, the third ecosystem defining a third programming language native to automation equipment of the third ecosystem.

15. The industrial computing system of claim 14, wherein the instructions further configure the apparatus to:
determine that the third programming language is native to the automation equipment of the third ecosystem; and
based on the request and responsive to determining that the second and third ecosystems define second and third program languages, respectively, generating, by the generator module, a second interface between the second and third ecosystems,
wherein the second interface defines code that translates the second programming language such that the request from the first ecosystem can be satisfied at least in part by the third ecosystem.
